(19) United States
(12) Patent Application Publication
(10) Pub. No.: US 2008/0218018 A1
(43) Pub. Date: Sep. 11, 2008

(54) COOLING FAN AND METHOD OF FABRICATION

(75) Inventors: QIANG ZHANG, Shenzhen (CN); WUN-CHANG SHIH, Tu-Cheng (TW); RUI-JUN HUANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/736,535

(22) Filed: Apr. 17, 2007

(30) Foreign Application Priority Data
Mar. 9, 2007 (CN) 200710073465.X

(51) Int. Cl. H02K 7/00; H02K 5/16; F04B 17/00

(52) U.S. Cl. 310/90; 310/67 R; 417/354; 417/423.12

(57) ABSTRACT

A cooling fan includes a fan housing (10) having a central tube (15) extending upwardly therefrom, a bearing (20) defining a bearing hole (22) therein, a stator (30) mounted on the central tube, and a rotor (40) including a hub (12) having a shaft (18) extending from the hub into the bearing hole of the bearing. The bearing is received and fixedly connected to the central tube during the plastic injection molding of the fan housing; thus the bearing and the central tube are integrally connected together. The bearing can be precisely and firmly secured to the central tube of the fan housing.

### BACKGROUND OF THE INVENTION

1. Field of the Invention

The present invention relates to a cooling fan, and more particularly relates to a cooling fan which can be assembled easily. The present invention relates also to a method for making the cooling fan.

2. Description of Related Art

With the continuing development of the electronic technology, electronic packages such as CPUs (central processing units) are generating more and more heat that requires immediate dissipation. Cooling fans are commonly used in combination with heat sinks for cooling CPUs.

A conventional cooling fan includes a rotor having a shaft extending downwardly from a central portion of the rotor, a bearing defining an inner hole for receiving the shaft therein, and a frame. A central tube extends upwardly from a middle portion of the frame and defines a through hole therein. The bearing is mounted in the through hole of the central tube of the frame. To avoid swinging of the bearing, the bearing is fixedly assembled to the central tube by interferential fitting. However, as the frame is generally made of plastic, when the bearing is placed into the central tube, an inner circumferential periphery of the frame may easily wear out. Thus a clearance may be formed between the bearing and the central tube when the bearing is assembled with the central tube of the frame to form the cooling fan, which, in most of cases, results in instability of the bearing and unbalanced rotation of the rotor of the cooling fan. Thus not only assembly of the bearing is inconvenience, but also results in noise or malfunctioning of the cooling fan. The performance of the cooling fan is reduced, and the life-span is resultingly shortened.

What is needed, therefore, is a cooling fan which can reduce or eliminate lubricant oil loss.

### SUMMARY OF THE INVENTION

The present invention relates, in one aspect, to a cooling fan. The cooling fan includes a fan housing having a central tube extending upwardly therefrom, a bearing defining a bearing hole therein, a stator mounted around the central tube, and a rotor including a hub having a shaft extending from the hub into the bearing hole of the bearing. The bearing is received and fixedly connected to the central tube during the process of molding the fan housing; thus the bearing and the central tube are integrally connected together during injection molding of the fan housing.

The present invention relates, in another aspect, to a method for making the cooling fan. The method includes steps of: a) providing a bearing; b) mounting the bearing in a mold used for making a fan housing; c) molding the fan housing using injection molding, a central tube being formed fixedly connected to the bearing and around the bearing during the process of molding the fan housing; d) mounting a stator around the central tube; e) mounting a rotor to the bearing.

Other advantages and novel features of the present invention will be drawn from the following detailed description of the preferred embodiments of the present invention with attached drawings, in which:

### BRIEF DESCRIPTION OF THE DRAWINGS

Many aspects of the present cooling fan can be better understood with reference to the following drawings. The components in the drawings are not necessarily drawn to scale, the emphasis instead being placed upon clearly illustrating the principles of the present cooling fan. Moreover, in the drawings, like reference numerals designate corresponding parts throughout the several views.

FIG. 1 is an isometric, exploded view of a cooling fan in accordance with a preferred embodiment of the present invention;

FIG. 2 is an assembled, cross sectional view of a fan housing and a bearing of the cooling fan in FIG. 1;

FIG. 3 is an enlarged view of a circled portion III of FIG. 2;

FIG. 4 is a flat, unrolled view of a bearing pattern of the bearing of FIG. 2;

FIG. 5 is an isometric view of the bearing of FIG. 2 with a sealing cover mounted thereon;

FIG. 6 is a cross sectional view of the bearing of FIG. 6 mounted in a mold being used for making the fan housing of the cooling fan;

FIG. 7 is an isometric view of the fan housing with a stator mounted therearound;

FIG. 8 is a view similar to FIG. 7, with the sealing cover on the bearing being removed;

FIG. 9 is an isometric, assembled view of the cooling fan; and

FIG. 10 is a cross sectional view of the cooling fan taken along line X-X of FIG. 9.

### DETAILED DESCRIPTION OF THE INVENTION

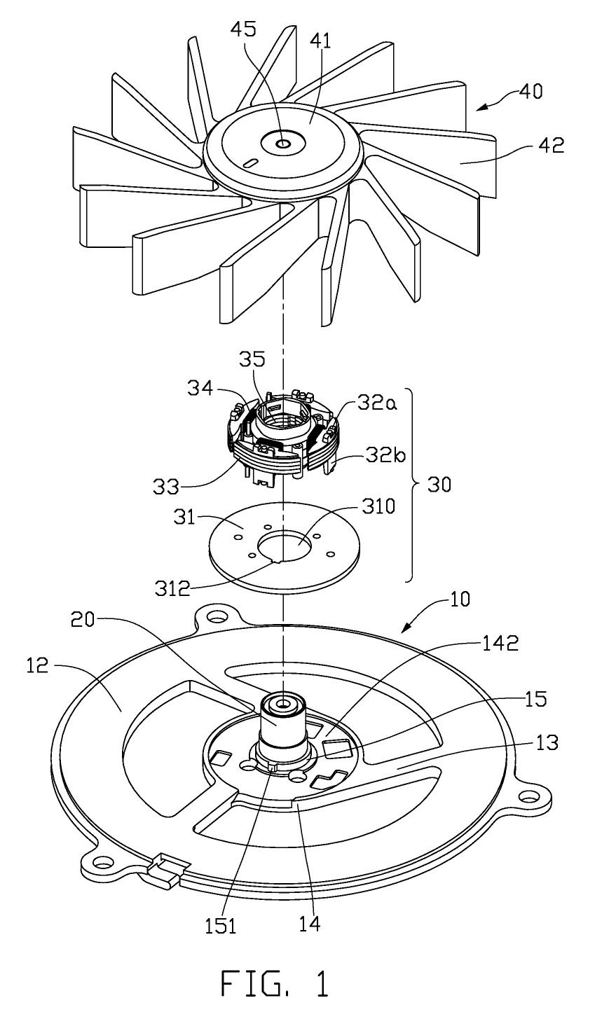

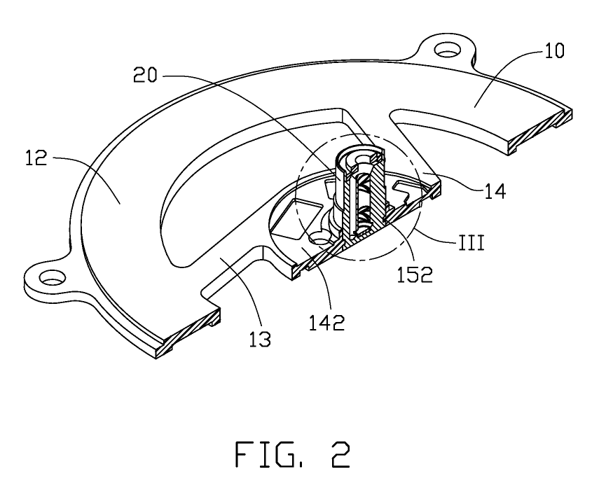

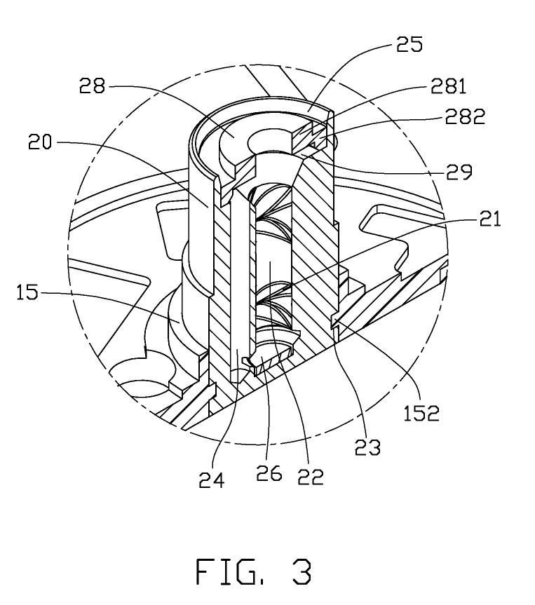

Referring to FIGS. 1-3, a cooling fan according to a preferred embodiment of the present invention includes a fan housing 10, a bearing 20 mounted in the housing 10, a stator 30 mounted around the bearing 20, and a rotor 40 being rotatablely supported by the bearing 20.

The housing 10 includes a ring shaped main body 12 defining an aperture (not labeled) in a central portion thereof, a base 14 being formed in the aperture of the housing 10, and a plurality of ribs 13 interconnecting an outer periphery of the base 14 and an inner periphery of the main body 12. The base 14 defines a concave 142 in a central portion thereof. A central tube 15 extends upwardly from the base 14 from a central area of the concave 142. An ear 151 extends radially and outwardly from an outer surface of the central tube 15. The ear 151 has a shape of square column which has a square shaped cross section. Alternatively, the ear 151 can be a semicircular column with a semicircular shaped cross section. An annular flange 152 extends radially and inwardly from an inner surface of a bottom end of the central tube 15. The ear 151 and the flange 152 are integrally formed with the central tube 15 of the housing 10.

The stator 30 is mounted on the central tube 15. The stator 30 includes a stator core 33 consisting of layered yokes, stator coils 34 wound on the stator core 33 to establish an alternating magnetic field, and a PCB 31 (printed circuit board) electrically connected with the stator coils 34. To avoid the coils 34 from coming into electrical contact with the stator core 33, upper and lower insulating frames 32a, 32b are used to cover the stator core 33 and electrically insulate the stator coils 34 from the stator core 33. The PCB 31 defines a mounting hole 310 for extension of the central tube 15 therethrough. A cutout 312 is defined in an inner circumference of the PCB 31 corresponding to a configuration and a position of the ear 151 of the central tube 15. When the stator 30 is mounted on the central tube 15, the ear 151 of the central tube 15 engages with the cutout 312 of the PCB 31 to fix the PCB 31 to the central tube 15.

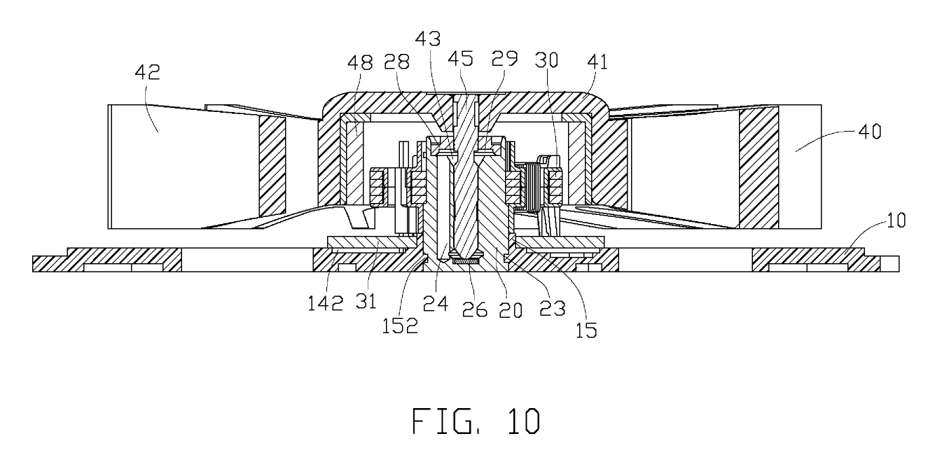

Also referring to FIG. 10, the rotor 40 includes a hub 41, a plurality of fan blades 42 extend radially from an outer periphery of the hub 41, a magnet 48 attached to an inner surface of the hub 41, and a shaft 45 extending downwardly from a central portion of the hub 41. The shaft 45 defines an annular slot 43 in a circular circumference thereof, near a top end adjacent to the hub 41.

The bearing 20 is mounted in the central tube 15. The bearing 20 defines a bearing hole 22 therein for extension of the shaft 45 therethrough. The bearing 20 is U-shaped with a bottom end closed and a top end open. A counter plate 26 made of high abrasion-resistant material is arranged in the bottom end of the bearing 20. When the shaft 45 is mounted into the bearing hole 22, the counter plate 26 faces and supportively engages a free end of the rotary shaft 45. The bearing 20 defines an end opening 25 at the top end thereof. The end opening 25 has a diameter larger than that of the bearing hole 22. An oil-retaining cover 28 is mounted in the end opening 25 of the bearing 20. The cover 28 having an upper portion 281 with an inner diameter approximately the same as a diameter of the shaft 45, and a lower portion 282 with an inner diameter larger than the diameter of the shaft 45. When assembled the upper portion 281 of the cover 28 is mounted around the shaft 45 with a position higher than the slot 43 of the shaft 45, and the lower portion 282 of the cover 28 is arranged on the top end of the bearing 20. An oil-retaining space 29 is thus formed between the shaft 45, the top end of the bearing 20 and the cover 28. A ventilating path 24 extends through the bearing 20 along an axial direction thereof. The ventilating path 24 is offset from the axis of the bearing 20 and communicates a bottom of the bearing hole 22 with an exterior of the bearing 20. When the shaft 45 of the rotor 40 is mounted in the bearing hole 22, air in the bearing hole 22 is able to escape along the ventilating path 24 to the exterior of the bearing 20.

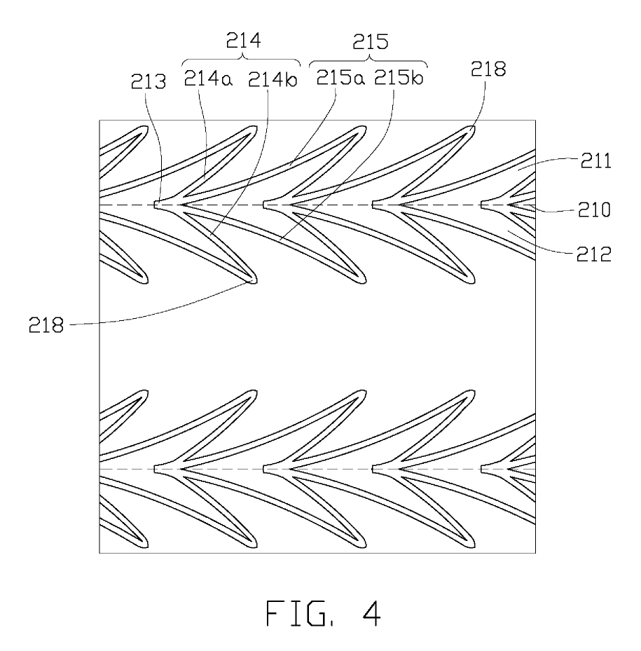

Referring to FIG. 4, in a preferred embodiment, a cylindrical bearing pattern 21 is formed on an inner surface of the bearing 20 and the bearing pattern 21 is filled with lubricating oil. Alternatively, the bearing pattern 21 can be formed on the outer surface of the rotary shaft 45. The cylindrical bearing pattern 21 is displayed in a flat diagram for the sake of clarity. The bearing pattern 21 comprises an upper half 211 and a lower half 212 bounded by a centerline 210. A plurality of V-shaped first grooves 214 and second grooves 215 are arranged circumferentially in an alternate fashion along extension of the bearing pattern 21. Each first groove 214 has arc-shaped first and second branches 214a, 214b formed at the upper and lower halves 211, 212 of the bearing pattern 21 respectively. Each second groove 215 has arc-shaped first and second branches 215a, 215b formed at the upper and lower halves 211, 212 of the bearing pattern 21 respectively. The first and second branches 214a, 214b of each first groove 214 and the first and second branches 215a, 215b of an neighboring second groove 215 converge in a central area of the bearing pattern 21 to form an inner communication end 213 thereat. The first and second branches 214a, 214b of each first groove 214 respectively communicate with the first and second branches 215a, 215b of another neighboring second groove 215 at the top and bottom edges of the bearing pattern 21 to form two outer communication ends 218.

In the upper half 211 of the bearing pattern 21, every three adjacent first branches, i.e., two first branches 214a of the first grooves 214 plus one intermediate first branch 215a of the second groove 215, or two first branches 215a of the second grooves 215 plus one intermediate first branch 214a of the first groove 214, co-operatively form a Z-shaped groove. In the lower half 212 of the bearing pattern 21, every three adjacent second branches, i.e., two second branches 214b of the first grooves 214 plus one intermediate second branch 215b of the second groove 215, or two second branches 215b of the second grooves 215 plus one intermediate second branch 214b of the first groove 214, co-operatively form a Z-shaped groove. Two groups of continuous Z-shaped grooves are thereby symmetrically formed respectively at upper and lower halves 211, 212 of the bearing pattern 21. The two groups of Z-shaped grooves intersect at the centerline 210 of the bearing pattern 21. By this arrangement, each groove of the bearing pattern 21 is in communication with one of its neighboring grooves, i.e., one first groove 214 and one neighboring second groove 215, are in communication with each other, either at the inner communication ends 213 or at the outer communication ends 218.

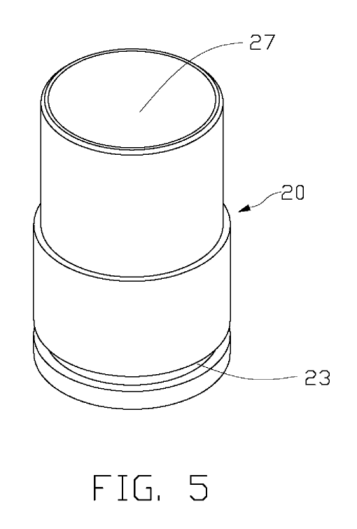

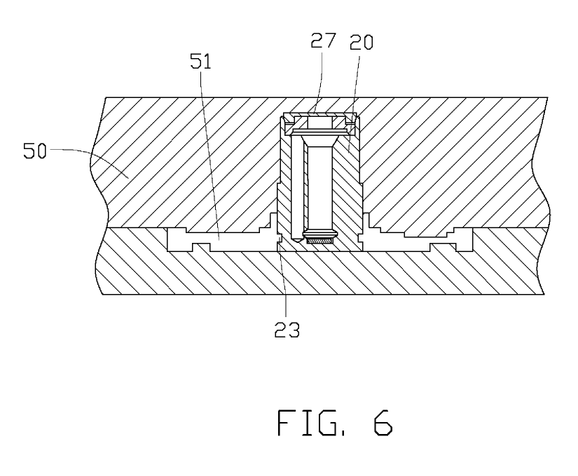

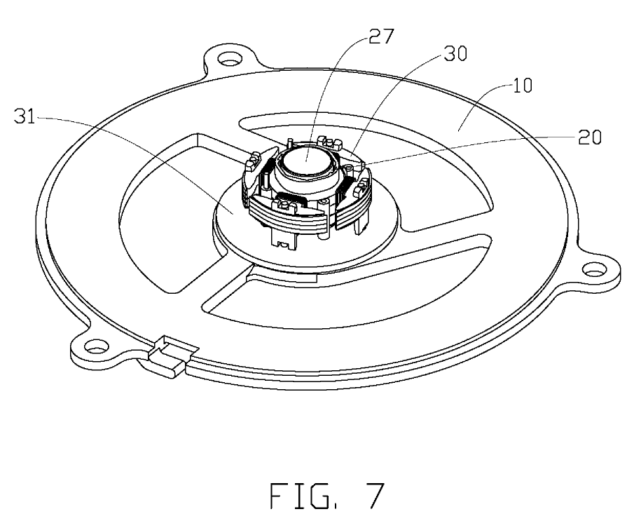

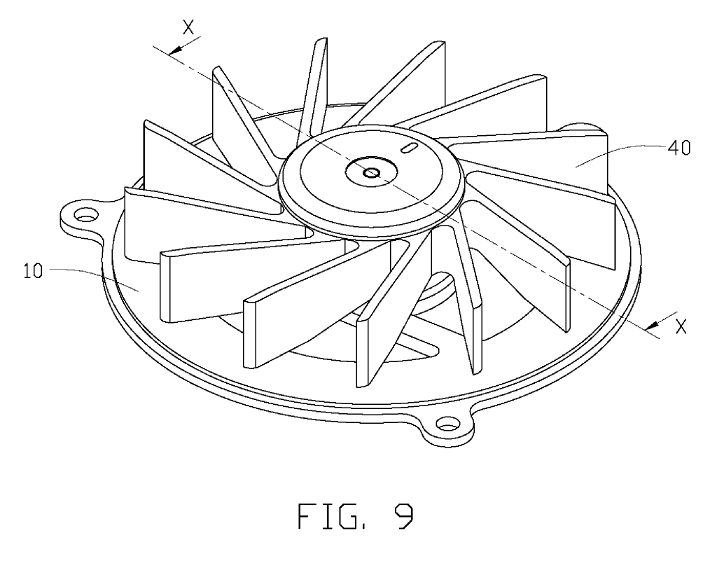

FIGS. 5-10 illustrate various stages of a preferred method for assembly of the cooling fan in accordance with the preferred embodiment of the present invention. Firstly, the bearing 20 is provided and a predetermined amount of lubricating oil is injected into the bearing hole 22 of the bearing 20. A sealing cover 27 is mounted on the top end of the bearing 20 to help prevention of the oil from leakage and foreign articles from entering the bearing hole 22 during the assembly of the cooling fan. As shown in FIG. 6, the bearing 20 is mounted in a mold 50 which is used for making the fan housing 10. The mold 50 has a chamber 51 for injecting molten plastic thereinto. After cooling the molten plastic in the chamber 51 forms the fan housing 10. The central tube 15 is integrally formed with the fan housing 10, and is fixedly adhered to the outer surface of the bearing 20. An annular flange 152 is formed in the notch 23 of the bearing 20. Thus the bearing 20 is received and fixedly connected to the central tube 15 during the process of molding the fan housing 10; and the bearing 20 and the central tube 15 are integrally connected together. Assembly of the bearing 20 into the central tube 15 of the conventional art by forcibly inserting the bearing into the central tube is avoided by the present invention. In this way friction between the bearing 20 and the central tube 15 during mounting of the bearing 20 to the central tube 15 is avoided. Thus the bearing 20 is assembled with the fan housing 10 precisely and stably, and production and assembly of the cooling fan are both easy and convenient.

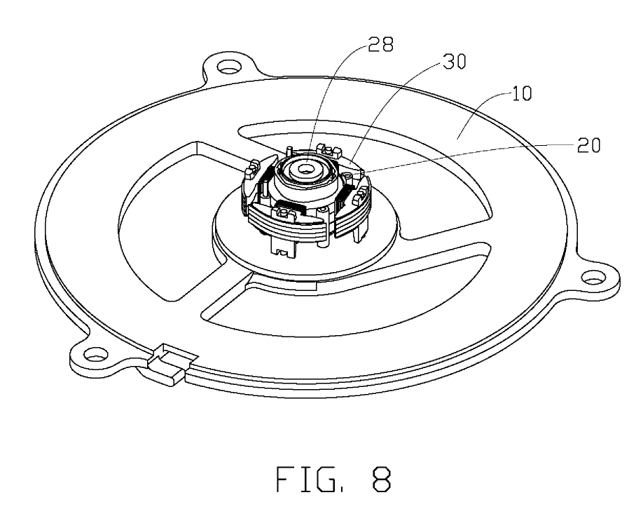

As shown in FIG. 8, the stator 30 is then mounted on the central tube 15 of the fan housing 10 and around the bearing 20. The rotor 40 is then assembled with the shaft 45 extending into the bearing hole 22 of the bearing 20, thus rotatably engaging with the bearing 20 to form the cooling fan. Before mounting the rotor 40, the sealing cover 27 mounted on the top end of the bearing 20 is removed. During operation, the rotor 40 is driven to rotate by the interaction of the alternating magnetic field of the stator 30 and the magnetic field of the rotor 40. Due to the bearing 20 being fixedly fitted in the fan housing 10, the bearing 20 is stable and thus enables the cooling fan to run smoothly, stably and with less vibration. Furthermore, the lubricating oil in the bearing pattern 21 establishes dynamic pressures against the rotary shaft 45. The lubricating oil at the outer communication ends 218 is driven towards the inner communication ends 213 through the first and second branches 214a, 214b, 215a, 215b of the first and second grooves 214, 215, under a centrifugal pumping force caused by rotation of the shaft 45. The high fluid pressures resulting from the accumulation of lubricating oil at the inner communication ends 213 separates the rotary shaft 45 and the bearing 20. In this way the rotary shaft 45 is prevented from physically contacting the inner surface of the bearing 20 during rotation thereof, thereby improving the quality and life-span of the cooling fan.

It is understood that the invention may be embodied in other forms without departing from the spirit thereof. Thus, the present example and embodiment are to be considered in all respects as illustrative and not restrictive, and the invention is not to be limited to the details given herein.

What is claimed is:

1. A cooling fan comprising:
a fan housing made of plastic injection molding and having a central tube extending upwardly therefrom;
a bearing being received and fixedly connected to the central tube during process of molding the fan housing, with a bearing hole being defined in the bearing;
a stator mounted on the central tube and around the bearing; and
a rotor comprising a hub having a shaft extending from the hub into the bearing hole of the bearing.

2. The cooling fan as claimed in claim 1, wherein an annular flange extends radially and inwardly from an inner surface of the central tube, and the bearing defines an annular notch in an outer surface thereof receiving the flange therein.

3. The cooling fan as claimed in claim 1, wherein a bearing pattern is formed on an inner surface of the bearing.

4. The cooling fan as claimed in claim 3, wherein the bearing pattern comprises a plurality of first and second grooves arranged circumferentially in an alternate fashion, each of the first grooves being in communication with one neighboring second groove at an edge of the bearing pattern.

5. The cooling fan as claimed in claim 4, wherein each of the first grooves is V-shaped and has first and second branches, each of the second grooves is V-shaped and has first and second branches, and the first and second branches of each of the first grooves communicate with the first and second branches of one neighboring second groove at top and bottom edges of the bearing pattern.

6. The cooling fan as claimed in claim 5, wherein the first and second branches of each of the first grooves and the first and second branches of another neighboring second groove converge in a central area of the bearing pattern.

7. The cooling fan as claimed in claim 5, wherein each branch is arc-shaped.

8. The cooling fan as claimed in claim 1, wherein the bearing forms a ventilating path therein communicating the bearing hole with an exterior of the bearing.

9. The cooling fan as claimed in claim 1, wherein the stator comprises a circuit board defining a mounting hole for extension of the central tube therethrough, a cutout being defined in an inner circumference of the circuit board, the central tube forming an ear on an outer surface thereof engaging with the cutout of the circuit board.

10. The cooling fan as claimed in claim 1, wherein the bearing defines an end opening that is larger than the bearing hole in diameter at a top end thereof, and an oil-retaining cover is mounted in the end opening of the bearing, the cover having an upper portion with an inner diameter approximately the same as a diameter of the shaft, and a lower portion with an inner diameter larger than the diameter of the shaft, a oil-retaining space being formed between the shaft, the bearing and the cover.

11. A method for making a cooling fan, comprising:
providing a bearing;
mounting the bearing into a mold being used for making a fan housing;
molding the fan housing using injection molding, a central tube being fixedly connected to the bearing and formed around the bearing during the process of molding the fan housing;
mounting a stator on the central tube; and
mounting a rotor to the bearing.

12. The method of claim 11, wherein the bearing comprises an annular notch defined in an outer surface thereof, the central tube forming an annular flange in the notch during the process of molding the fan housing.

13. The method of claim 11, wherein the bearing has a closed end and an open end, a sealing cover is mounted on the open end to seal the open end before mounting the rotor to the bearing.

14. The method of claim 11, wherein during the process of molding the fan housing, an ear is integrally formed on an outer surface of the central tube, and the stator comprises a circuit board defining a cutout receiving the ear therein when mounting the stator on the central tube.
